(19) United States
(12) Patent Application Publication
(10) Pub. No.: US 2008/0256468 A1
(43) Pub. Date: Oct. 16, 2008

(54) METHOD AND APPARATUS FOR DISPLAYING A USER INTERFACE ON MULTIPLE DEVICES SIMULTANEOUSLY

(76) Inventors: Johan Christiaan Peters, Sankt Leon-Rot (DE); Michael Richter, Hamburg (DE); Sebastian Scholz, Saabruecken (DE)

Correspondence Address: SAP AG, 3410 HILLVIEW AVENUE, PALO ALTO, CA, 94304, US

(21) Appl. No.: 11/734,265

(22) Filed: Apr. 11, 2007

(51) Int. Cl. G06F 15/16

(52) U.S. Cl. 715/764; 709/248

(57) ABSTRACT

Disclosed is a method and system for displaying a user interface of an application on a source device in a source format and on a target device in a target format simultaneously. The target device electronically coupled to the application on the source device is identified and the target format of the user interface is determined in runtime based on the target device. The user interface is displayed on the target device in the target format and on the source device in the source format simultaneously. A state of the user interface on the target device and the source device is synchronized.

### FIELD OF THE INVENTION

The invention relates to the field of graphical user interface and more particularly to a method and apparatus for displaying a user interface on multiple devices simultaneously.

### BACKGROUND OF THE INVENTION

In a multi user environment, it is desirable to run an application simultaneously on a federation of devices. The federation may include a variety of devices such as laptop, personal digital assistants, mobile phones, and projectors. The problem that may arise in such a scenario is displaying a user interface of the application on multiple devices which may have a display of different size, different environment etc. Consider the user interface of an application on a source device such as desktop which has a format that may include images, text, a complex layout, and other graphical content. A user may find it comfortable to read information in the user interface when the user interface is displayed on a desktop screen but may find it difficult to read the information in the user interface when the user interface is displayed in the above format on devices that have a relatively smaller display size such as a mobile phone or a pocket pc. The user may have to scroll the user interface repeatedly to view the information in the user interface. Also, if the user interface has a complex layout such as multiple frames, for example, 2 horizontal frames and 2 vertical frames, displaying the user interface on devices with a smaller display size may not be optimal for viewing.

A user interface that is designed for a device such as mobile phone that has a relatively smaller display size may have a format with certain characteristics such as simple layout, text in a smaller font, less number of images, and smaller image size. If the user interface is displayed in the same format on a device such as a laptop or an overhead projector that has a relatively larger display size, then the text may not be visible properly or the images may be small which may not be optimal for viewing on a larger display. Thus displaying a user interface simultaneously on a federation of devices for optimal viewing and user interaction may be complex.

### SUMMARY OF THE INVENTION

What is described is a system and method for displaying a user interface of an application on a source device in a source format and on a target device in a target format simultaneously. The target device electronically coupled to the application on the source device is identified and the target format of the user interface is determined in runtime based on the target device. The user interface is displayed on the target device in target format and on the source device in source format simultaneously. A state of the user interface on the target device and the source device is synchronized.

### BRIEF DESCRIPTION OF THE DRAWINGS

FIG. 1 is a block diagram of a system that displays a user interface of an application on a source device in a source format and on a target device in a target format according to an embodiment of the invention.

FIG. 2 is a block diagram of a system to synchronize state of user interface on source device and target device according to an embodiment of the invention.

FIG. 3 is an example screen display of a payment cards user interface of an application designed for a desktop according to an embodiment of the invention.

FIG. 4 and FIG. 5 is an example screen display of FIG. 3 for payment cards user interface designed for a pocket pc according to an embodiment of the invention.

FIG. 6 is a flow diagram for displaying a user interface on a source device and target device simultaneously according to an embodiment of the invention.

FIG. 7 is a flow diagram for determining target format of a user interface to be displayed on a target device according to an embodiment of the invention.

FIG. 8 is a flow diagram for determining target format of a user interface to be displayed on a target device according to an embodiment of the invention.

FIG. 9 is a flow diagram for synchronizing state of a user interface displayed on a target device and a source device according to an embodiment of the invention.

### DETAILED DESCRIPTION

A user interface of an application is displayed on a source device in a source format and on a target device in a target format simultaneously. The target device electronically coupled to the application on the source device is identified and the target format of the user interface is determined in runtime based on the target device. The user interface is displayed on the target device in target format and on the source device in source format simultaneously. State of the user interface on the target device and the source device is synchronized.

The source device and target device may include devices such as desktops, laptops, tablet personal computer (pc), pocket pc, mobile phone and smart phone.

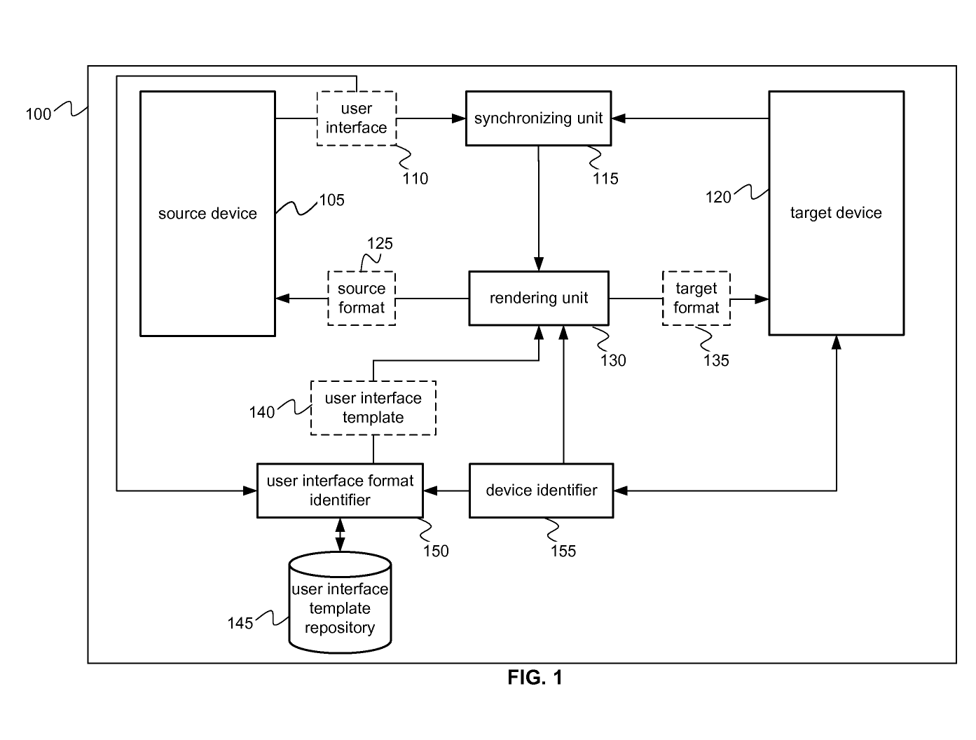

FIG. 1 is a block diagram of a system that displays a user interface of an application on a source device in a source format and on a target device in a target format according to an embodiment of the invention. System 100 includes a source device 105 which displays a user interface 110 of an application in source format 125 and a target device 120 which displays user interface 110 in target format 135. System 100 includes device identifier 155 that identifies target device 120 electronically coupled to the application on source device 105. User interface format identifier 150 determines target format 135 for user interface 110 by fetching user interface template 440 from user interface template repository 145. System 400 includes a rendering unit 130 that displays user interface 110 in source format 125 on source device 105 and in target format 135 on target device 120. Synchronizing unit 115 synchronizes state of user interface 110 on source device 105 and target device 120. Synchronizing unit 115 may ensure that data displayed in user interface 110 on target device 120 and source device are consistent. In an embodiment, synchronizing unit 115, rendering unit 130, device identifier 155, and user interface format identifier 150 may reside in source device 105.

Source device 105 may include a device such as desktop. User interface 110 is displayed on source device 105 in source format 125. User interface 110 in source format 125 may include a number of images, and number of frames. Navigation in user interface 110 may be provided through keyboard shortcuts and a pointing device such as mouse. User interface 110 may also be displayed on target device 120 simultaneously. The target device 120 may include a device such as pocket pc or an overhead projector which may be different from source device 105. If target device 120 is a pocket pc, then display size of pocket pc is much smaller than a desktop, the runtime environment of pocket pc may be different from that of desktop. Thus, user interface 110 may have to be displayed on target device 120 in a format that may be different from source format 125 of user interface 110 displayed on source device 105. Source format 125 of user interface 110 includes a number of images, number of frames, and navigation through keyboard which may not be suitable for pocket pc that has a display which is smaller compared to a desktop and does not have a keyboard. Considering the display size of the pocket pc, user interface 110 may have to be displayed in target format 135 that includes fewer images, fewer frames, and navigation through pointing device such as stylus. Thus, target format 135 may have to be determined based on target device 120. After target format 135 is determined, user interface template 140 of target format 135 is created and stored in a user interface template repository 145.

When target device 120 is electronically coupled to the application running on source device 105, device identifier 155 identifies target device 120 by determining properties of target device 120 such as display size, display resolution and runtime environment of target device 120. Device identifier 155 may communicate with operating system of target device 120 to determine the properties of target device 120. Runtime environment of target device 120 is an important factor because target device 120 may display user interface 110 in a web browser or as Java swing user interface or as a native user interface. Target format 135 is determined based on the properties of the target device 120 and a user interface template 140 is created for target format 135. User interface format identifier 150 identifies target format 135 for user interface 110 by fetching user interface template 140 from user interface template repository 145 based on the target device 120 identified by device identifier 155. Rendering unit 130 displays user interface 110 in target format 135 on target device 120 using user interface template 140. Rendering unit 130 displays user interface 110 on source device 105 in source format 125 and on target device 120 in target format 135 simultaneously. Rendering unit 130 displays user interface 110 on source device 105 and target device 120 according to the runtime environment of source device 105 and target device 120 respectively.

The user interface template repository 145 contains user interface templates of various formats for various target devices. User interface template repository 145 may be updated with user interface templates for target devices the application on source device 105 intends to support.

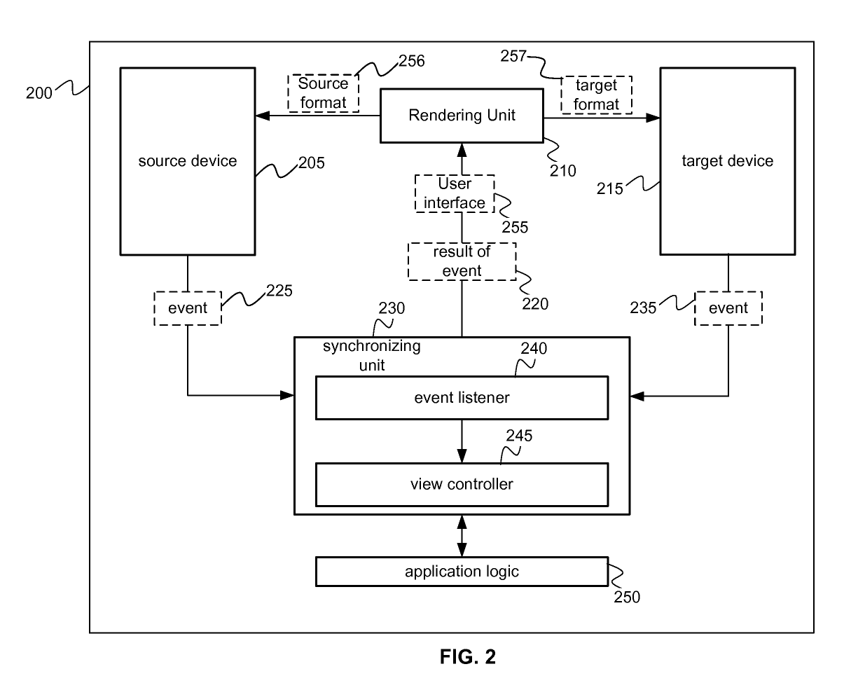

FIG. 2 is a block diagram of a system to synchronize state of user interface on source device and target device according to an embodiment of the invention. System 200 includes source device 205 and target device 215 that displays a user interface 255 simultaneously. Rendering unit 210 displays user interface 255 on source device 205 in source format 256 and on target device 215 in target format 257 simultaneously. Synchronizing unit 230 synchronizes state of the user interface 255 on source device 205 and target device 215. Event Listener 240 in synchronizing unit 230 listens to event 225 from source device 205 and event 235 from target device 215. An event 225 from source device 205 is captured by event listener 240 and passed to view controller 245 for processing. Processing the event 225 includes responding to the event 225 based on application logic 250 that may include updating user interface 255 with new data or navigating to a new user interface or changing values of fields in the user interface 255. Event 225 and event 235 may include events such as user event, and application event. Examples of user event include click of a button in user interface, and mouse click. Example of application event includes refreshing the user interface automatically. Synchronizing unit 230 process the event 225 and passes the result of event 220 to rendering unit 210 to display the user interface 255 updated with result of event 220 on the source device 205 and target device 215. The result of the event 220 may be updated in source device 205 or in target device 215 or in both based on type of the event 225. In an embodiment, if an event 225 is captured for resizing the user interface 255 on source device 205, then only the user interface 255 on source device 205 is updated. In another embodiment, if values in the user interface 255 on source device 205 are changed, the event 225 is captured and the result of the event 220 may be updated in user interface 255 on both source device 205 and target device 215. Thus, synchronizing unit 230 keeps the user interface 255 on the target device 215 and source device 205 synchronized.

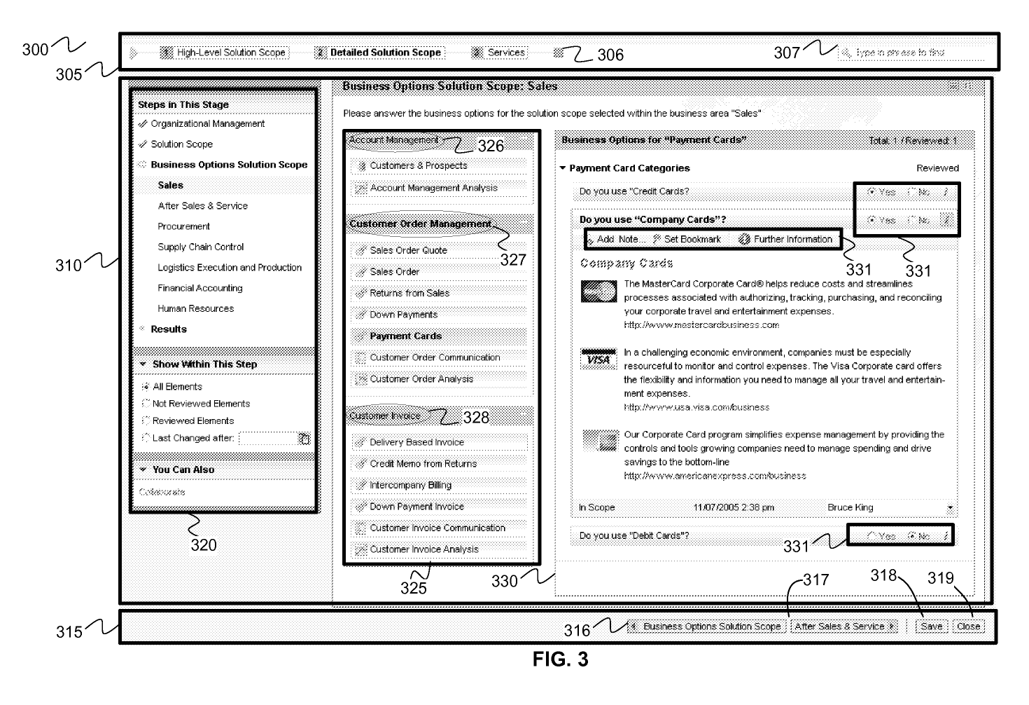

FIG. 3 is an example screen display of a payment cards user interface of an application designed for a desktop according to an embodiment of the invention. The application allows a user to configure business options for various business areas such as sales, after sales & service, and procurement as depicted in 320. The user interface 300 is designed for a device such as desktop. The user interface 300 presents the information to the user in a source format that includes three horizontal panes 305, 310 and 315, three vertical panes 320, 325 and 330. The user may navigate to different business areas by selecting a business area in vertical pane 320. The user may navigate to different functionalities of the business area that are listed under account management 326, customer order management 327, and customer invoice 328 provided in vertical pane 325. Vertical pane 330 displays payment card categories information to the user. The user may configure business options for the payment card categories in 330 by providing details at 331. The horizontal pane 305 contains a breadcrumb 306 that displays path and current solution scope. The horizontal pane 305 also contains a textbox 307 for entering a search term. The horizontal pane 315 displays possible actions that may be performed on payment card categories user interface 300. The user may navigate to a business area next or previous to the “Sales” business area in 320 which is “After sales & service” and “Business options solution scope” using buttons 317 and 316 respectively. The user may also save the configuration of payment card categories 330 using button “Save” 318 and close user interface 300 using button “Close” 319. Thus navigation between various business areas of the application and various functionalities within the business area is provided via vertical panes 320 and 325. Considering display size of desktop, the source format in which user interface 300 is presented to the user may have an optimal viewing and usability on desktop.

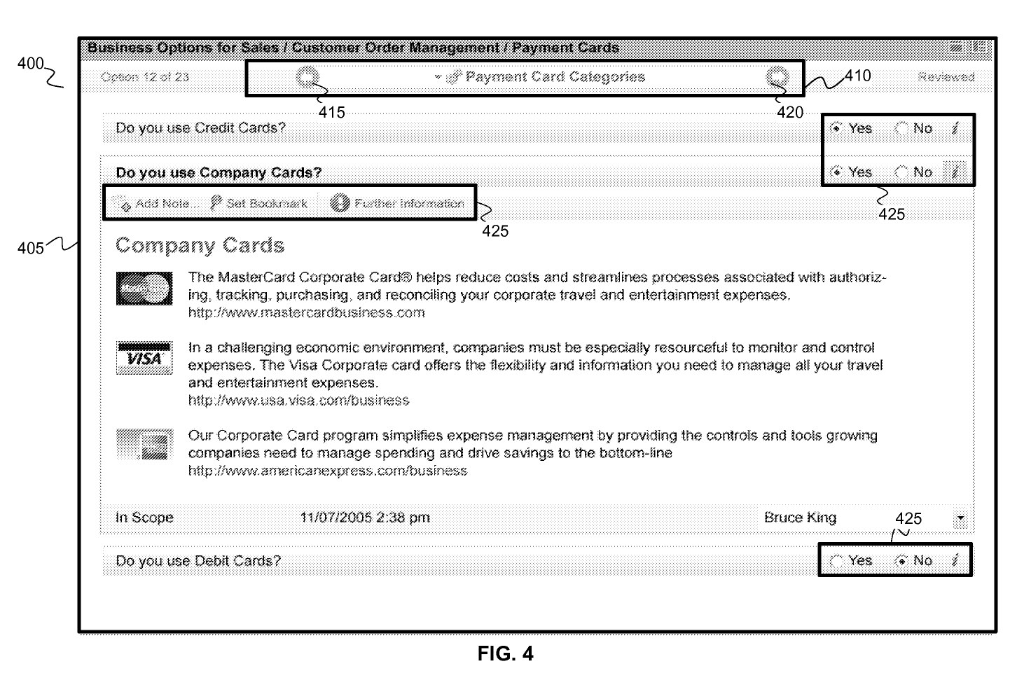

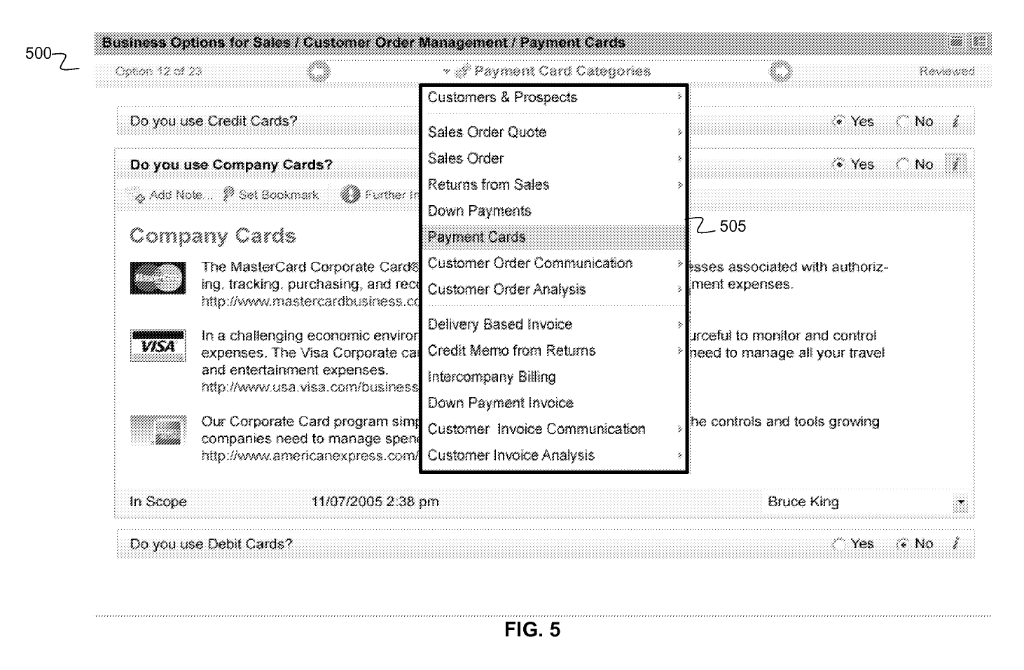

FIG. 4 and FIG. 5 is an example screen display of FIG. 3 for payment cards user interface designed for a pocket pc according to an embodiment of the invention. The payment cards user interface 300 (as shown in FIG. 3) may not be suitable to be viewed on a device such as pocket pc since the pocket pc has smaller display compared to a desktop. Since user interface 300 has a number of vertical and horizontal panes, text in user interface 300 may be compressed which makes it to difficult to read or the user may have to scroll user interface 300 repeatedly to view whole user interface 300 on pocket pc. Thus, user interface 300 may not have an optimal viewing and usability on pocket pc. Thus, payment cards user interface 300 may have to be formatted to be viewed on pocket pc.

The payment cards user interface 400 is formatted for a device such as pocket pc that has a smaller display compared to a desktop. The payment cards user interface 400 displays the information contained in payment cards user interface 300 in a different format. The payment cards user interface 400 is displayed in a target format that may have optimal viewing and usability on pocket pc. Since, the pocket pc has a relatively smaller display than a desktop user interface 400 may not have many vertical panes and horizontal panes as in user interface 300 which is designed for a desktop screen. The target format of the user interface 400 includes one pane 405. The user interface 400 displays the payment card category information in pane 405. The user may configure business options for payment card category by providing details at 425. The user may navigate to different functionalities of the business area by choosing a functionality from dropdown list 410. The dropdown list 505 includes all functionalities of a business area. The functionalities of a business area provided in vertical pane 325 in user interface 300 are included as dropdown list 505. The user may also navigate between functionalities in dropdown list 505 using button 415 and button 420. In an embodiment the user may navigate from “Payment cards” functionality to next functionality “Customer Order Communication” by clicking the button 420. Button 420 allows the user to navigate to next functionality of the business area and if current functionality displayed is last functionality of the business area, then first functionality of the next business area may be displayed. In another embodiment, a business area dropdown list may be provided in user interface 400 to navigate between the business areas. The business area dropdown list may include all the business areas displayed in vertical pane 320 in user interface 300. Thus, a user interface may be displayed in various formats for various devices based on device properties.

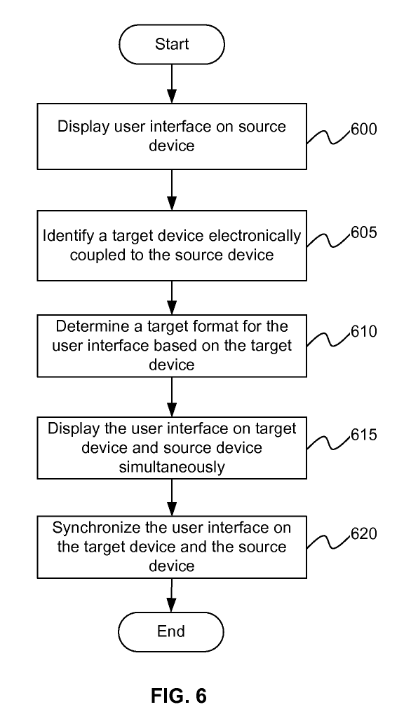

FIG. 6 is a flow diagram for displaying a user interface on a source device and target device simultaneously according to an embodiment of the invention. The user interface of an application is displayed in a source format on the source device at 600. At 605, the target device electronically coupled to the application on the source device is identified. At 610, a target format for the user interface displayed in the source device is determined based on the target device identified in 605. At 615, the user interface is displayed on the target device in target format and on the source device in source format simultaneously. The user interface displayed on the target device and the source device is synchronized as and when state of the user interface in either source device or target device changes due to an event occurring in the user interface or the application as described at 620.

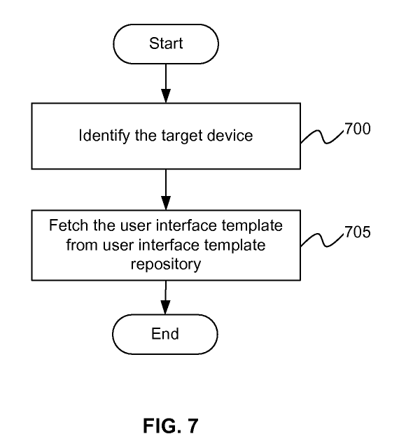

FIG. 7 is a flow diagram for determining target format of a user interface to be displayed on a target device according to an embodiment of the invention. At 700, the target device electronically coupled to an application on a source device is identified. The target device properties such as display size, display resolution and runtime environment of the target device are determined. At 705, the target format for the user interface is determined by fetching a user interface template from user interface template repository for the target device identified at 700.

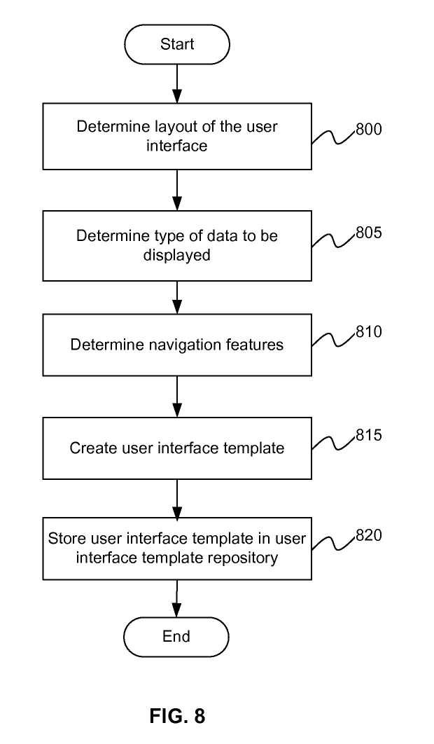

FIG. 8 is a flow diagram for determining target format of a user interface to be displayed on a target device according to an embodiment of the invention. At 800, layout of the user interface is determined for the target device based on the target device properties that may include display size, display resolution and runtime environment of the target device. Determining the layout of the user interface for the target device includes determining factors such as the number of horizontal and vertical frames that the user interface may have, positioning of the frames for better readability and user accessibility based on the target device type. At 805, type of data that may be displayed in the user interface for the target device is determined based on the target device properties that may include display size, display resolution and runtime environment of the target device. Determining type of data to be displayed in the user interface for the target device includes determining whether the user interface may include images, videos, size and the number of images that may be included, whether the UJ may contain applets. At 810, navigation features that may be provided in the user interface for the target device is determined based on the target device properties that include device type, display size, display resolution and runtime environment. Navigation features such as navigation through keyboard shortcuts, drop down lists, and means of displaying tool tips in the user interface may have to be determined based on the target device. In an embodiment, if the target device is a pocket pc, then navigation through keyboard shortcuts may not be suitable since the pocket pc may not have a keyboard, displaying tooltip via a mouse over event may not suitable, displaying a command list on right-click of a mouse button may not be suitable as the mouse is not a standard pointing device used to navigate in the pocket pc. In another embodiment, if the target device is a desktop, navigation features using keyboard shortcuts may be suitable; displaying tooltip via mouse over event may be suitable. At 815, the target format of the user interface is determined by creating a user interface template that includes layout, type of data and navigation features determined for the target device as described in 800, 805 and 810 respectively. The user interface template created in 815 is stored in a user interface template repository as depicted at 820.

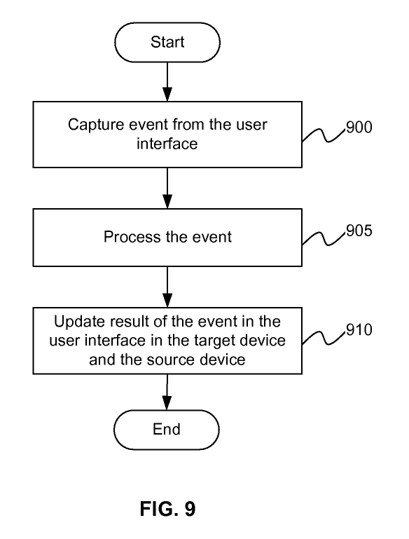

FIG. 9 is a flow diagram for synchronizing state of a user interface displayed on a target device and a source device according to an embodiment of the invention. At 900, an event is captured from the user interface. The event could either be from the target device or the source device or from both. The event may include user event such as click of a button, and application event such as refreshing user interface at regular intervals of time. At 905, the event is processed according to application logic. Processing of the event may include fetching data from database, navigating from the user interface to another user interface, changing values on the user interface, and resizing the user interface. At 910, the result of the event is updated in the user interface. The result of the event may be updated in only source device or only in target device or both based on type of the event. In an embodiment, if an event for resizing the user interface is captured from the user interface on the source device, then only the user interface on the source device may be updated. In another embodiment, if values in the user interface on the source device are changed, the event is captured and the result of the event are updated in the user interface on both source device and target device.

Embodiments of the invention may include various steps as set forth above. The steps may be embodied in machine-executable program code which causes a general-purpose or special-purpose processor to perform certain steps. Alternatively, these steps may be performed by specific hardware components that contain hardwired logic for performing the steps, or by any combination of programmed computer components and custom hardware components.

Embodiments of the present invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or any other type of machine-readable media suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. Accordingly, the scope and spirit of the invention should be judged in terms of the claims which follow.

What is claimed is

1. A method, comprising:
displaying a user interface of an application on a source device in a source format;
identifying a target device electronically coupled to the application on the source device;
determining a target format for the user interface based on the target device;
displaying the user interface simultaneously on the target device in the target format and on the source device in the source format; and
synchronizing state of the user interface on the target device and the source device.

2. The method in claim 1, wherein identifying the target device comprises determining target device parameters selected from a group consisting of type of display and runtime environment of the target device.

3. The method in claim 2, wherein determining the type of the display of the target device comprises determining a display parameter selected from a group consisting of display resolution and form factor of the display of the target device.

4. The method in claim 2, wherein identifying the target device comprises communicating with an operating system of the target device to identify the target device.

5. The method in claim 1, wherein determining the target format comprises:
determining a layout of the user interface based on type of display of the target device;
determining a type of data to be displayed with the user interface; and
determining a navigation feature to be provided in the user interface.

6. The method in claim 5 further comprising creating a user interface template for the target device based on the target format and storing the user interface template in a user interface template repository.

7. The method in claim 1, wherein determining the target format of the user interface comprises fetching a user interface template from a user interface template repository based on the target device.

8. The method in claim 1, wherein synchronizing the state of the user interface on the target device and the source device comprises:
capturing an event in the user interface;
processing the event; and
updating result of the event in the user interface on the target device and the source device.

9. The method in claim 1, wherein displaying the user interface on the target device comprises displaying the user interface based on runtime environment of the target device.

10. A system, comprising:
a source device that displays a user interface of an application in a source format;
a device identifier that identifies a target device electronically coupled to the application on the source device;
a user interface format identifier that determines a target format for the user interface based on the target device;
a rendering unit that displays the user interface in the target format on the target device and in the source format on the source device; and
a synchronizing unit electronically coupled to the source device and target device that synchronizes state of the user interface on the target device and the source device.

11. The system in claim 10, wherein the device identifier communicates a type of display of the target device and runtime environment of the target device to user interface format identifier and rendering unit.

12. The system in claim 10 further comprising a user interface template repository that contains a user interface template for the target format.

13. The system in claim 10, wherein the user interface format identifier fetches a user interface template for the target format from a user interface template repository based on the target device.

14. The system in claim 10, wherein the synchronizing unit comprises an event listener that captures an event in the user interface and the application.

15. The system in claim 10, wherein synchronizing unit further comprises a view controller that processes the event and updates result of the event in the user interface in the target device and the source device.

16. The system in claim 15, wherein the view controller processes the event by communicating with application logic of application on the source device.

17. An article of manufacture, comprising:
a machine readable medium having instructions which when executed by a machine cause the machine to:
display a user interface of an application on a source device in a source format;
identify a target device electronically coupled to the application on the source device;
determine a target format for the user interface in runtime based on the target device;
display the user interface simultaneously on the target device in the target format and the source device in source format; and
synchronize state of the user interface on the target device and the source device.

18. The article of manufacture in claim 17, wherein the machine readable medium provides instructions, which when executed by a machine cause the machine to identify the target device by determining type of display and runtime environment of the target device.

19. The article of manufacture in claim 17, wherein the machine readable medium provides instructions, which when executed by a machine cause the machine to determine the target format of the user interface by fetching a user interface template from a user interface template repository based on the target device.

20. The article of manufacture in claim 17, wherein the machine readable medium provides instructions, which when executed by a machine cause the machine to synchronize the user interface by
capturing an event in the user interface;
processing the event; and
updating result of the event in the user interface on the target device and the source device.
